(19) United States
(12) Patent Application Publication
(10) Pub. No.: US 2017/0344341 A1
(43) Pub. Date: Nov. 30, 2017

(54) RATE DOMAIN NUMERICAL PROCESSING CIRCUIT AND METHOD

(71) Applicant: Raytheon Company, Waltham, MA (US)

(72) Inventors: Harry Bourne Marr, JR., Manhattan Beach, CA (US); Jeffery Jay Logan, Redondo Beach, CA (US); Daniel Thompson, Norman, OK (US)

(21) Appl. No.: 15/167,346

(22) Filed: May 27, 2016

(51) Int. Cl. G06F 7/38

(52) U.S. Cl. CPC G06F 7/38

(57) ABSTRACT

Rate domain numerical processing comprises receiving an input serial data stream on a single input wire in which a multi-valued number is represented as a rate of pulse events comprising pulses, null pulses or a combination thereof. The rate of pulse events in an output serial data stream is varied in accordance with an operand to perform a multi-valued arithmetic operation selected from multiplication, division, addition and subtraction or a combination thereof. The rate may be varied by scaling the rate by an operand, which may be implemented using a count and compare circuit topology. The output serial data stream is output on a single output wire. The rate domain operations, specifically multiplication and division are accomplished without the resource & power intensive binary multiplier and binary divisions circuits. The operations are implemented using simple registers, adders, accumulators, counters, comparators, and basic logic, which is far more SWaP-C efficient.

### BACKGROUND OF THE INVENTION

### Field of the Invention

This invention relates to numerical processing, and more particular to a method and circuit for numerical processing in a rate domain.

### Description of the Related Art

High-speed communication and processing of data is ubiquitous. More specifically, digital circuitry and binary logic is widely used to process digital data in which multi-valued numbers are represented as N-bit binary words. A serial data stream carries 1 bit at a time sequentially. A parallel data stream may carry N bits in parallel. Typically, data is transported in a serial data stream to minimize cost in the form of I/O pins and interconnects and locally processed in parallel to maximize speed. A Serializer/Deserializer (SerDes pronounced sir-deez) is a pair of functional blocks used to convert data between serial data and parallel interfaces.

Most typically, arithmetic operations including add, subtract, multiply and divide are performed with standard binary logic with 8 to 64-bit fixed and floating-point data formats. Circuit topologies to implement a binary multiply or binary divide are all based on the principle of “shift and add” or “shift and subtract”, respectively. There are many variants on this basic concept to increase processing speed.

The binary multiplier and divider circuits consume a lot of SWaP-C (“Size, Weight, Power and Cost” resources in typical FPGA and ASIC implementations. In addition, the copper wires that form interconnects have not shrunk at the same rate as the circuits to implement the binary logic circuits. These wires are becoming more and more expensive in terms of both capacitance and energy.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a method and circuit for numerical processing of multi-valued numbers in a serial data stream. The numbers are represented and processed in a “rate domain” in which each number is represented as a rate of pulse events. The rate domain operations, specifically multiplication and division are accomplished without the resource and power intensive binary multiplier and binary divisions circuits. The operations are implemented using a simple topology of registers, adders, accumulators, counters, comparators, and basic logic, which is far more SWaP-C efficient. Rate domain operations use a single wire rather than a bus of wires common for standard binary processing.

In an embodiment, rate domain numerical processing comprises receiving an input serial data stream on a single input wire in which a multi-valued number is represented as a rate of pulse events comprising pulses, null pulses or a combination thereof. The rate of pulse events in an output serial data stream is varied in accordance with an operand to perform a multi-valued arithmetic operation selected from multiplication, division, addition and subtraction or a combination thereof. The output serial data stream is output on a single output wire.

In an embodiment, the rate is varied by scaling the rate by the operand (e.g., a rational number). In an embodiment, pulse events are counted and the count is compared to the operand to scale the rate.

In different embodiments, the rate may be represented by the “counts per frame”, “pulse frequency” or “pulse position.” All pulse events are weighted with respect to time within a repetition frame. Representations in which the pulse events have equal weights are referred to as “unweighted”. Representations in which the pulses have unequal weights as, for example, a function of position or order are referred to as “weighted”. Unequal weighting may allow for more compact or efficient representation and processing of multi-valued numbers.

In different embodiments, rate domain numerical processing may be implemented using digital, analog, photonic or other technologies and binary or other logic formats. The ability to implement rate domain processing with a simple topology standard digital gates/binary logic such as accumulators, comparators, adders etc. configured to temporally process serial data on a single wire is a significant advantage. Critically, the implementation does not require the use of traditional binary multipliers or dividers. Rate domain numerical processing may be implemented in FPGA and ASIC technologies.

In different embodiments, rate domain numerical processing may be synchronous (e.g., to a clock) or asynchronous (e.g., to the occurrence of pulse events).

In different embodiments, rate domain numerical processing may be implemented serially or in parallel. For parallel processing, the input serial data stream is deserialized into N data streams. The rate domain arithmetic operations is duplicated and performed on each of the N data streams in parallel, which are then serialized to form the output data stream.

In different embodiments, the rate domain numerical processing operations of multiplication, division, addition and/or subtraction may be combined to implement filters, amplifier/attenuators, mixers, couplers, other RF and optical circuits, modulations, convolution, dot products, FFT/IFFTs, and any signal/image processing functions, matrix math, vectorized arithmetic.

In different embodiments, the input serial data stream may represent multi-valued numbers in a different format e.g., binary. The multi-valued numbers may be converted from that different format into a rate domain representation and processed in the rate domain. The output serial data stream may be generated in the rate domain or converted back to the different format. This allows the efficiencies of rate domain processing to be incorporated into systems that use other data formats such as binary.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a block diagram of a circuit and method of numerical processing in a rate domain;

FIGS. 2a, 2b and 2c are respectively “counts per frame”, “pulse frequency” and “pulse position” embodiments of rate domain numerical processing;

FIGS. 3-5 are embodiments of a division, multiplication and addition operations in the rate domain for the “counts per frame” representation;

FIGS. 6a-6d are a sequence of plots of a serial data stream illustrating division, multiplication and addition operations in the rate domain for the “counts per frame” representation;

FIG. 7 is an embodiment of a numerical processing circuit for performing division, multiplication, addition and subtraction operations in the rate domain for the “pulse frequency” representation;

FIGS. 8a and 8b are embodiments of the “divisor” and “adder” operand circuits for the numerical processing circuit of FIG. 7;

FIG. 9 is an embodiment of the transcoder for the “divisor” and “adder” circuits;

FIGS. 10a-10d are a sequence of plots of a serial data stream illustrating division, multiplication and addition operations in the rate domain for the “pulse frequency” representation; and

FIG. 11 is an embodiment of an adder in the rate domain for the “pulse position” representation.

### DETAILED DESCRIPTION OF THE INVENTION

The present invention provides a method and circuit for numerical processing of multi-valued numbers in a serial data stream. The numbers are represented and processed in a “rate domain” in which each number is represented as a rate of pulse events. The rate domain operations, specifically multiplication and division are accomplished without the resource & power intensive binary multiplier and binary divisions circuits. The operations are implemented using simple registers, adders, accumulators, counters, comparators, and basic logic, which is far more SWaP-C efficient.

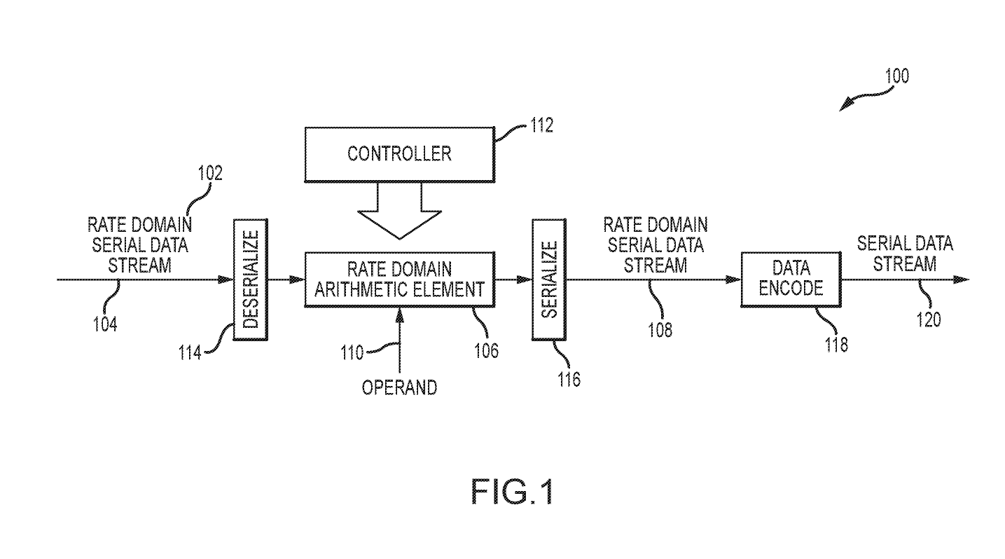

Referring now to FIG. 1, a system 100 for rate domain numerical processing receives an input serial data stream 102 on a single input wire 104. The input serial data stream represents multi-valued numbers in a “rate domain”. More specifically, each multi-valued number is represented as a rate of “pulse events”, which comprise pulses, null pulses or combinations thereof. For example, a “counts per frame” format represents the multi-valued number by the number of pulse events (weighted or unweighted) in a frame. A “pulse frequency” format represents the multi-valued number as a frequency of pulse events e.g. (pulses separated by number of null pulses). A “pulse position” format represents the multi-valued number by the position (e.g., time-slot) of a pulse in a frame. Other rate domain representations may be envisioned. The pulse events may be “unweighted” (have equal weights) or “weighted” (have unequal weights as a function of position (e.g., time slot or order) in the data stream. Weighting may allow for more compact or efficient representation of multi-valued numbers.

Logic circuitry is configured to form a rate domain arithmetic element 106 to vary the “rate” of pulse events in an output serial data stream 108 according to an “operand” 110 to perform a multi-valued arithmetic operation selected from multiplication, division, addition and subtraction or a combination thereof. The “rate” may be varied by “scaling” the rate up or down by the operand. In certain embodiments, “scaling” may be implemented using a “count & compare” topology for the logic circuitry. In an embodiment, digital technology is used to implement binary logic circuitry. The rate domain operations, specifically multiplication and division are accomplished without the resource & power intensive binary multiplier and binary division circuits. The operations are implemented using a simple topology of registers, adders, accumulators, counters, comparators, and basic logic configured to process serial data on a single wire, which is far more SWaP-C efficient.

In certain embodiments, a controller 112 configures an accumulator used to count the pulse events to implement either the unweighted or weighted representations. For example, for unweighted, the accumulator step-size may be set equal to a constant value of 1 thereby giving all pulse events equal weight. For weighted, the accumulator step-size may be a function of the position, order or timing of the pulse event as dictated by the particular weighting. In different embodiments, the arithmetic element may be configured to directly generate the output serial data stream in the weighted or unweighted representations.

In certain embodiments, a SerDes having a pair of functional blocks 114 (deserialize) and 116 (serialize) is used to convert data between serial data and parallel interfaces. The logic circuitry for rate domain arithmetic element 106 is replicated to process the data in the rate domain in parallel.

In certain embodiments, a data encode 118 is performed on the output serial data stream 108 to convert it to a serial data stream 120 in a different non-rate domain format. For example, the rate domain format may be converted to a binary format to interface with other standard digital communication or processing systems. A similar data encode may be used on the front end to convert, for example, a binary format to a rate domain format for processing.

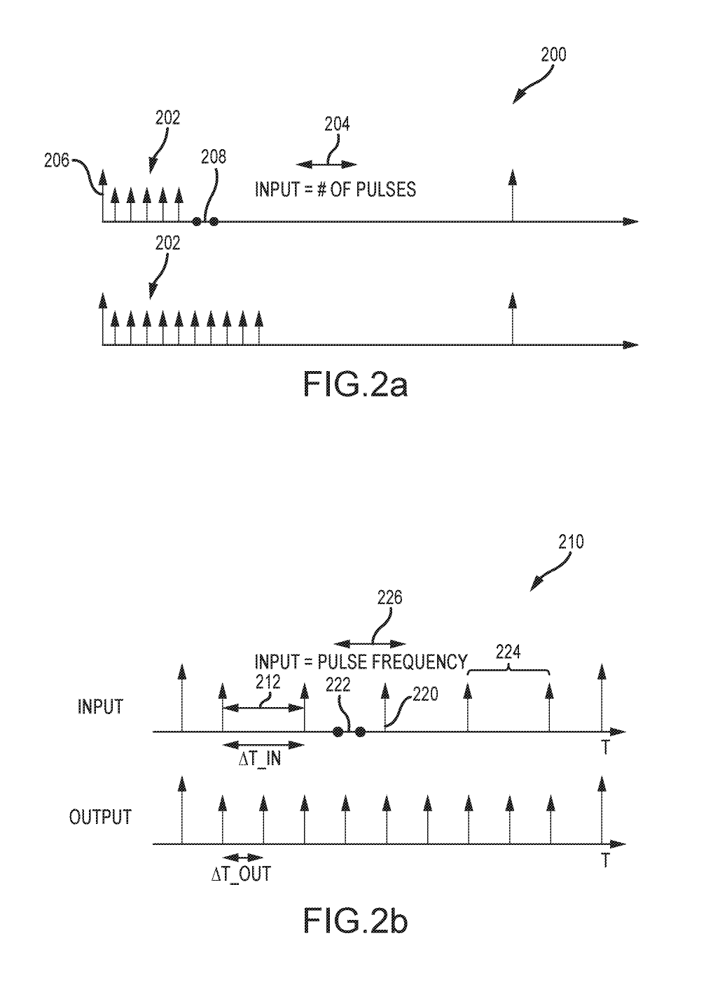

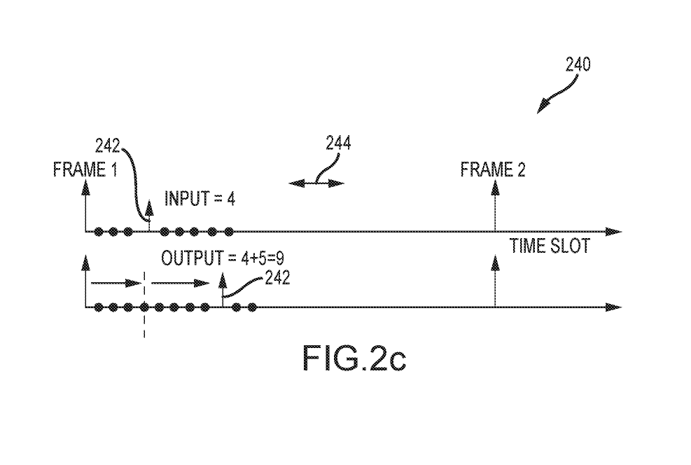

Multi-valued numbers are represented in a “rate domain”. More specifically, each multi-valued number is represented as a rate of “pulse events”, which comprise pulses, null pulses or combinations thereof. Many rate domain representations may be envisioned. A few that are designed for synchronous systems in which a clock establishes regular clock cycles or “time slots” are depicted in FIGS. 2a-2c.

As shown in FIG. 2a, a “counts per frame” format 200 represents the multi-valued number by the number of pulse events 202 (weighted or unweighted) in a frame 204. Typical, pulse event 202 is a binary pulse “1” but could be a null pulse or a combination thereof. Each frame 204 is defined by a frame reset pulse 206 and each pulse or null pulse occurs in a time slot 208.

As shown in FIG. 2b, a “pulse frequency” format 210 represents the multi-valued number as a frequency 212 of pulses 220. The frequency 212 is given by the Δt between pulses 220, which is equivalent to the number of null pulses 222 between pulses 220. Each “pulse frequency” unit 224 defined by a pair of pulses 220 and the null pulses 222 between them repeats within a frame 226 unless and until an input value changes or different processing is applied.

As shown in FIG. 2c, a “pulse position” format 240 represents a multi-valued number by the position (e.g., time-slot) of a pulse 242 in a frame 244. The number is equal to the occurrence of pulse 242 weighted by its time slot.

In these representative rate domain formats the frame size may be fixed or variable. For example, if the system is configured so that all of the counted pulse events occur at the beginning of a frame, once the pulse events have ceased the frame can be dynamically shortened e.g. insert an end-of-frame symbol. As processing increases or decreases the number of counts per frame the frame size can be dynamically changed. Similarly, for “pulse frequency” the frame size can be adjust dynamically to include a single unit and for “pulse position” the frame size can be adjust dynamically based on the position of the pulse. Dynamic windowing is more complex but may increase efficiency.

As mentioned, rate domain numerical processing may be implemented with digital, analog, photonic or other technologies. The logic may be based on a binary or other logic system. Rate domain processing may be implemented in a synchronous system tied to a clock or an asynchronous system tied to occurrence of pulse events. Rate domain processing may use weighted or unweighted representations.

For purposes of illustration and without loss of generality, embodiments of exemplary rate domain numerical processing circuits to perform the mathematical operations of division, multiplication and addition are presented for a digital technology using binary logic in a synchronous system. Although not shown, it is understood that each circuit includes a clock that synchronizes the operation of the standard binary logic circuits. In these examples, “pulse events” are binary pulses “1” and non-pulse events are binary null pulses “0”.

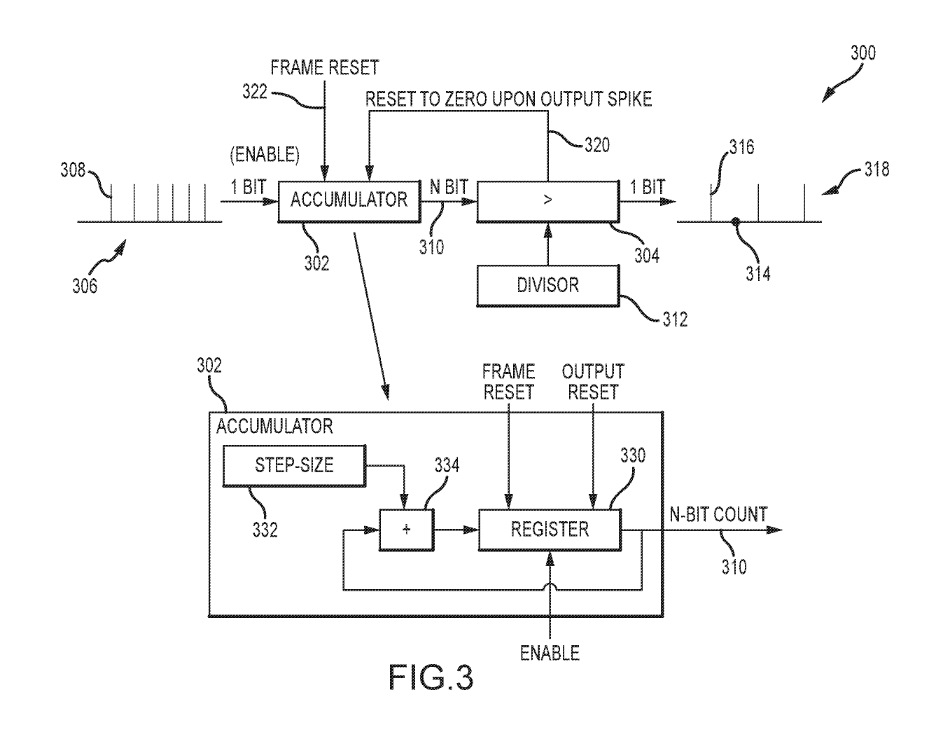

FIGS. 3-5 and 6a-6d illustrate an embodiment of a divider 300, a multiplier 400 and an adder 500 for an unweighted “counts per frame” representation and exemplary rate domain serial data streams 600, 602, 604 and 606 for a simple calculation of output=((input/b)*a)+c where the input has a numeric value of 50, a=3, b=5, c=4 and the output=19.

Referring now to FIG. 3, an embodiment of divider 300 includes an accumulator 302 and a comparator 304 implemented with standard binary logic circuits. Binary pulses 306 in an input serial data stream 308 enable accumulator 302 to count the corresponding clock cycle so that the accumulator generates an N-bit count 310 of the binary pulses 306. Null pulses do not enable the accumulator, and thus those clock cycles are not counted. Comparator 304 compares N-bit count 310 to an N-bit divisor 312 and generates either a null pulse 314 if count 310 is less than divisor 312 or a pulse 316 if count 310 is equal to or greater than divisor 312 in an output serial data stream 318. Divisor 312 may be a constant or a N-bit value for another input. When a pulse 316 is generated, an output reset signal 320 is generated to reset accumulator 302, typically to zero but in some cases to a remainder. Accumulator 302 is reset to zero at the beginning of every frame by a frame reset signal 322. For example, a division by 5, will generate a pulse 316 in the output serial data stream for every 5 input pulses received thereby scaling the counts per frame down by a factor of 5. Any remainders can be discarded.

An embodiment of accumulator 302 includes a register 330 that stores the N-bit count 310, a step-size input 332 an adder 334 that adds the step-size to the current N-bit count to update the N-bit count if the register is enabled by the occurrence of a binary pulse in the input serial data stream. For unweighted cases, the step-size is suitably a constant equal to one. For weighted cases, the step-size may vary dynamically according to the position of the binary pulse 306 in the frame.

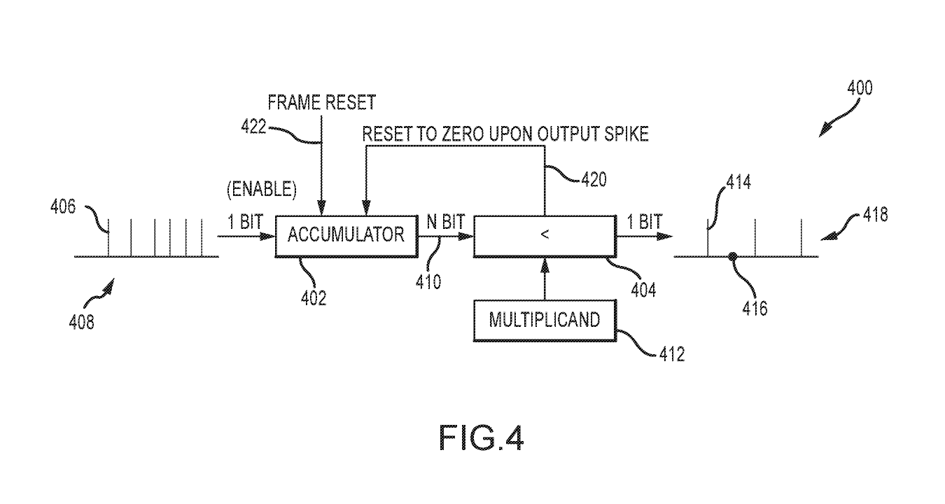

Referring now to FIG. 4, an embodiment of multiplier 400 includes an accumulator 402 and a comparator 404 implemented with standard binary logic circuits. Binary pulses 406 in an input serial data stream 408 enable accumulator 402 to count the corresponding clock cycle so that the accumulator generates an N-bit count 410 of the binary pulses 406. Null pulses do not enable the accumulator, and thus those clock cycles are not accumulated. Comparator 404 compares N-bit count 410 to an N-bit multiplicand 412 and generates either a pulse 414 if count 410 is less than or equal to multiplicand 412 or a null pulse 416 if count 410 is greater than multiplicand 412 in an output serial data stream 418. Multiplicand 412 may be a constant or an N-bit value for another input. When a null pulse 416 is generated, an output reset signal 420 is generated to reset accumulator 402 to zero. Accumulator 402 is reset to zero at the beginning of every frame by a frame reset signal 422. For example, a multiplication by 3 will generate three pulses 414 in the output serial data stream for every input pulse received thereby scaling the counts per frame up by a factor of 3. In order to replicate each pulse a multiplicand number of times, either the output rate of the serial data stream must be at least the multiplicand times higher than the input rate of the serial data stream or the multiplication operation must follow a division operation in which the divisor is greater than the multiplicand.

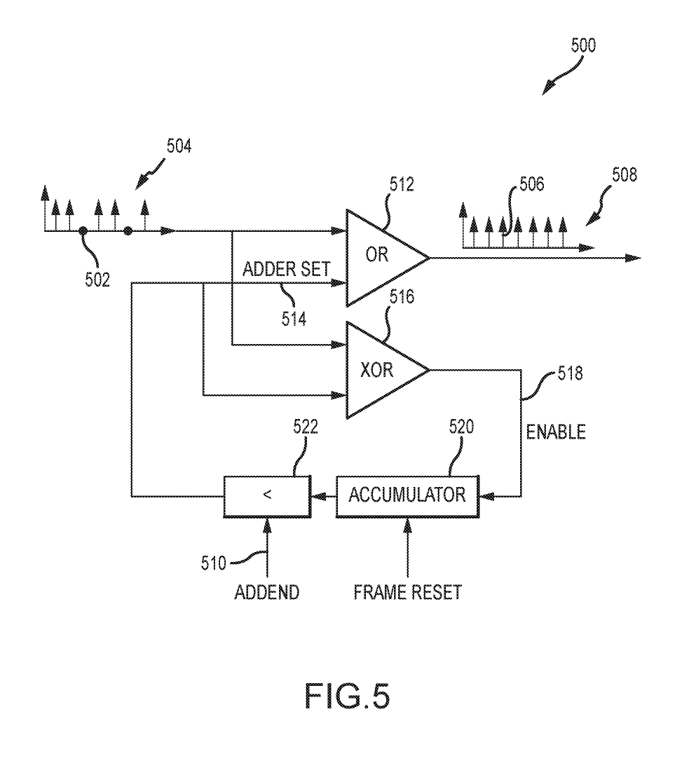

Referring now to FIG. 5, an embodiment of adder 500 is configured to detect a null pulse 502 in an input serial data stream 504, replace the null pulse with a pulses 506 in an output serial data stream 508 and repeat until a count of inserted pulses equals an addend 510. Adder 500 includes a two-input OR gate 512 that ORs input serial data stream 504 with an adder set 514, which is initially set equal to zero, to generate output serial data stream 508. A two-input XOR gate 516 XORs serial data stream 504 with adder set 514 to generate an enable signal 518, at least initially, upon the occurrence of a null pulse in the input serial data stream. Enable signal 518 enables an accumulator 520 to count a number of null pulses 502 (equal to the number of pulses 506 inserted into the output serial data stream 508). Once this count reaches the value of addend 510, a comparator 522 switches adder set 514 to zero. For the rest of the frame, adder set equal zero has no impact on the output of OR gate 512 and the output serial data stream. The accumulator count is reset to zero and adder set 514 to one at the beginning of each frame.

A subtraction operation is analogous to the addition operation. The subtractor detects a pulse in the input serial data stream, replaces the pulse with a null pulse in the output serial data stream and repeats until a count of inserted null pulses equals a subtractor operand. The circuit topology is similar except that the OR gate is replaced with an AND gate, adder set is initial set at zero and remains at zero until the count reaches the subtractor operand.

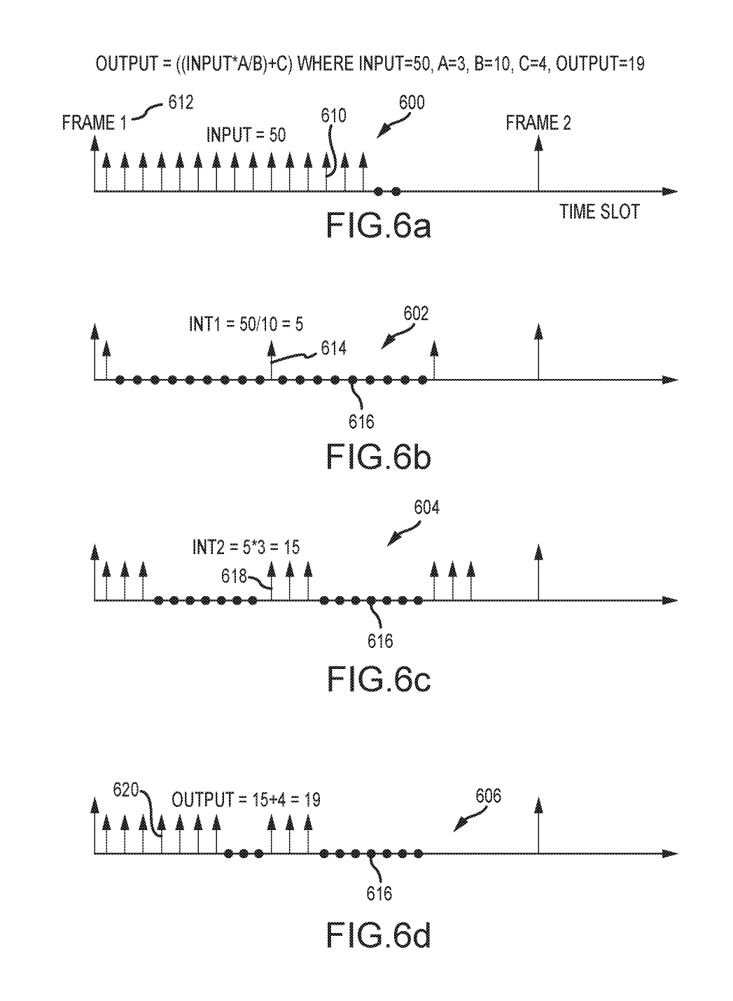

Referring now to FIGS. 6a-6d, rate domain serial data streams 600, 602, 604 and 606 depict the input serial data stream and the intermediate serial data streams for the division, multiplication and addition operations for a simple calculation of output=((input/b)*a)+c where the input has a numeric value of 50, a=3, b=10, c=4 and the output=19 for a “counts per frame” representation. Input serial data stream 600 has 50 pulses 610 in a frame 612. The division operation generates one pulse 614 for every 10 pulses 610 for a total of 5 pulses. This produces nine null pulses 616 between each pulse 614. The multiplication operation generates three pulses 618 for each of the five pulses 610 for a total of 15 pulses 618. The addition operation replaces four null pulses 616 with four pulses 620 for a total of 19 pulses.

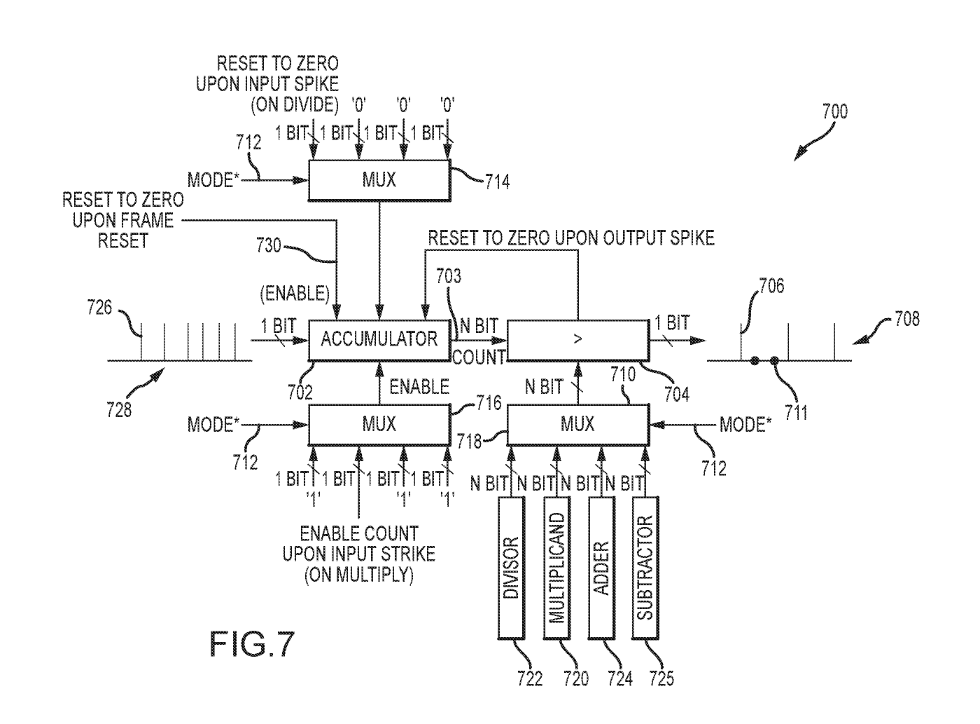

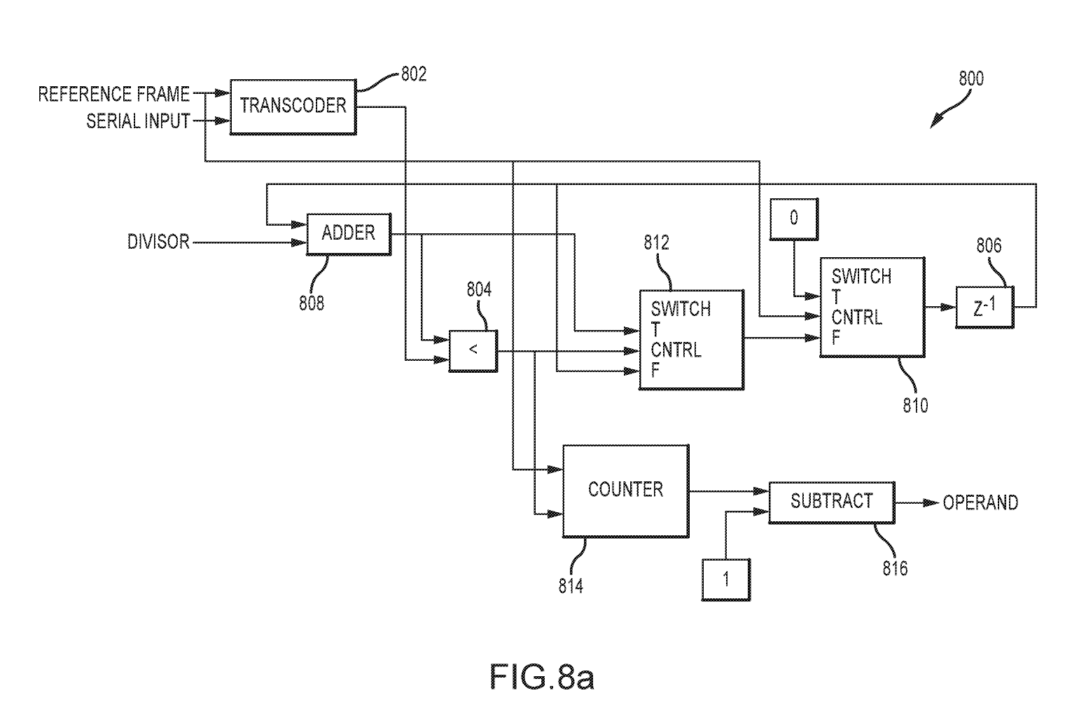

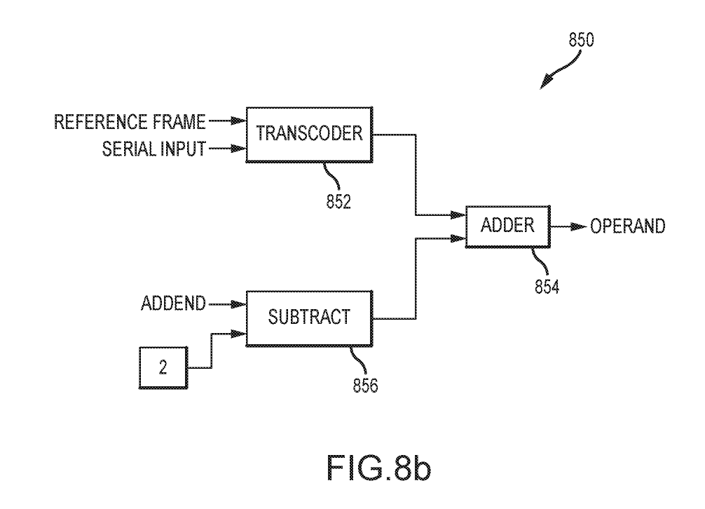

FIGS. 7, 8a-8b, 9 and 10a-10d illustrate an embodiment of a rate domain circuit topology 700 for an unweighted “pulse frequency” representation that is configurable to implement a divider, a multiplier, an adder or a subtractor. The basic topology includes an accumulator 702 that accumulates a count 703 of clock cycles when enabled and a comparator 704 that generates an output pulse 706 in an output serial data stream 708 when the count reaches a numeric value given by an N-bit operand 710. Otherwise the comparator generates null pulses 711 that are inserted into the output serial data stream 708. The different arithmetic operations are implemented by controlling the reset and enable conditions of an accumulator and setting the operand for the particular arithmetic operation. A mode 712 controls multiplexers (MUX) 714, 716 and 718 to select the arithmetic operation and switch the corresponding reset and enable to accumulator 702 and operand to comparator 704. The operand for a multiplication operation is the multiplicand provided by a multiplicand circuit 720. The operand for a division operation is a quotient of the input value and the divisor provided by a divisor circuit 722 (See FIG. 8a). The operand for an addition operation is a sum of the input value and the addend provided by an adder circuit 724 (See FIG. 8b). The operand for a subtraction operation is a difference of the input value and the subtractor provided by a subtractor circuit 725. Note: the value of the operand may be represented by a zero-based or one-based indexing representation.

To implement a division operation, the operand is set to the quotient of the input value for the frame and the divisor (accounting for any offset) provided by divisor 722. Accumulator 702 is always enabled for the division operation. The accumulator is reset to zero on the occurrence of any one or more of a frame reset 730, input pulse 726 in an input serial data stream 728 or generation of output pulse 706. The accumulator receives an input pulse 726 and starts accumulating clock cycles (corresponding to the null pulses following a pulse in the pulse frequency representation) to generate N-bit count 703. When count 703 reaches the operand, comparator 704 generates output pulse 706 in output serial data stream 708. The effect is to scale down the number of null pulses 711 that separate pulses 706 in output serial data stream 708 by the divisor. For example, an input value of 50 (a pulse followed by 49 null pulses) divided by a divisor of 10 produces a value of 5 (a pulse followed by 4 null pulses).

To implement a multiplication operation, the operand is set equal to the multiplicand (accounting for any offset) provided by multiplicand circuit 720. Accumulator 702 is only enabled by the occurrence of an input pulse 726 in input serial data stream 728. Accumulator 702 is reset to zero on the occurrence of frame reset 730 or the generation of output pulse 706. The accumulator is not reset by the occurrence of another input pulse in the frame. The accumulator 702 effectively counts input pulses 726. Comparator 704 generates null pulses 711 until the count reaches the operand at which point the comparator 704 generates an output pulse 706. The effect is to scale up the number of null pulses 711 that separate pulses 706 in output serial data stream 708 by the multiplicand. For example, an input value of 5 (a pulse followed by 4 null pulses) multiplied by a multiplicand of 3 produces a value of 15 (a pulse followed by 14 null pulses).

To implement an addition operation, the operand is set equal to the sum of the input value and the addend (accounting for any offset) provided by adder circuit 724. Accumulator 702 is always enabled for the division operation. Accumulator 702 is reset to zero on the occurrence of frame reset 730 or the generation of output pulse 706. The accumulator is not reset by the occurrence of another input pulse in the frame. The accumulator receives an input pulse 726 and starts accumulating clock cycles (corresponding to the null pulses following a pulse in the pulse frequency representation) to generate N-bit count 703. When count 703 reaches the operand, comparator 704 generates output pulse 706 in output serial data stream 708. The effect is to scale down the number of null pulses 711 that separate pulses 706 in output serial data stream 708 by a ration number equal to the quotient of the operand and the input value. For example, an input value of 15 (a pulse followed by 14 null pulses) summed with an added of 4 produces a value of 19 (a pulse followed by 18 null pulses). The subtraction operation differs only in that the operand is the difference of the input and the subtractor provided by subtractor circuit 725.

As previously described, to implement the division operation the operand is set to the quotient of the input value and the divisor accounting for any offset due to zero-indexing representation. To maintain the efficiency of rate domain numerical processing it is preferred that the quotient not be calculated using a binary divider. An embodiment of a divisor circuit 800 for computing the quotient for a “pulse frequency” representation is illustrated in FIG. 8a.

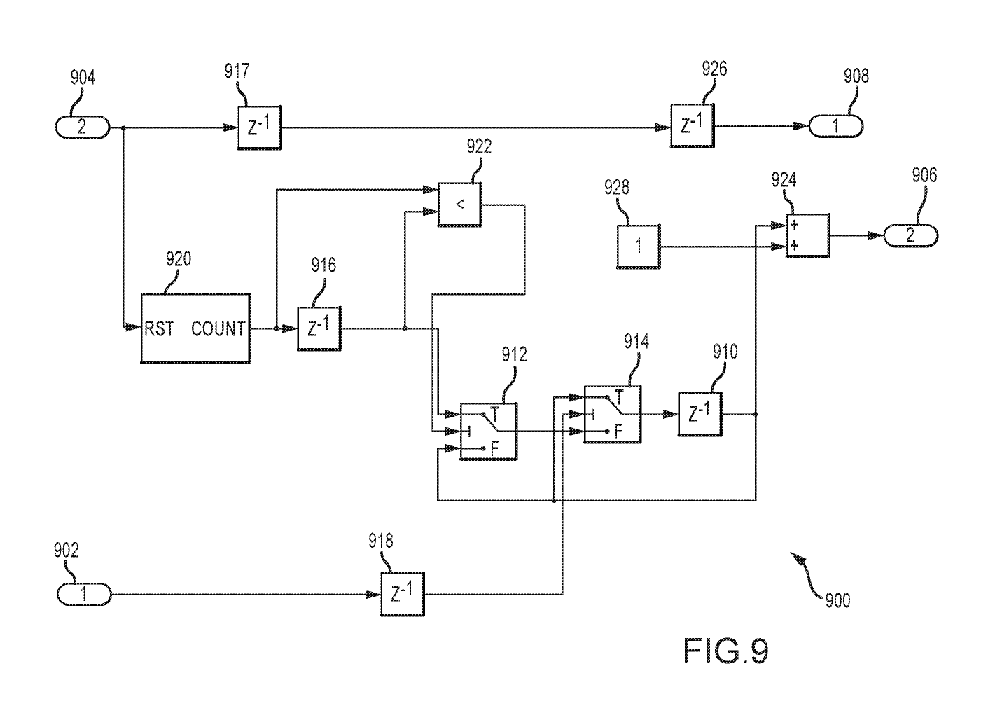

The rate domain reference frame (“frame reset) and the rate domain input serial data stream are fed into a transcoder 802 (see FIG. 9), which outputs a numeric representation of the input for each frame. A comparator 804 compares this output against a sum of the divisor (numeric) and a clocked register 806 produced by an adder 808. If the sum is less than the numeric input value, the comparator outputs true T. Otherwise the comparator outputs false F. The register is reset to 0 on each reference pulse by a switch 810 that toggles to a constant 0. The output of the comparator 804 toggles a switch 812 that passes the register's previous value in the case that the register value added to the divisor is greater than or equal to the numeric value of the input and passes the sum of the current register value and the divisor if the less than condition of the comparator is satisfied. A numeric counter 814 is enabled each time the less than condition is satisfied and is reset on a reference frame spike. The output of the counter is the operand used in the rate domain division circuit (after this value has been decremented by a subtract 816 in order to handle the zero-indexing representation).

As also previously described, to implement the addition operation the operand is set to the sum of the input value and the addend. An embodiment of an adder circuit 850 for computing the sum for a “pulse frequency” representation is illustrated in FIG. 8b. The rate domain reference window (“frame reset) and the rate domain input serial data stream are fed into a transcoder 852 (see FIG. 9), which outputs a numeric representation of the input. This output is summed using an adder 854 with an addend, which is decremented by two via a subtract 856 to handle the zero-indexing representation, and the output is the operand used in the rate domain addition circuit.

An embodiment of a transcoder 900 for computing a numeric representation from an input serial data stream in which multi-valued numbers are represented by pulse frequency is illustrated in FIG. 9. Inputs include a reference frame 902 and an input serial data stream 904. The transcoder outputs a numeric value 906 for each frame and a delayed copy 908 of the input serial data stream 904.

A counter 920 counts on every clock cycle to count the number of zeros between input pulses and is reset on an input pulse. A delay block 916 holds the value of the previous count value (assuming registers are clocked in the synchronized case). This register is updated on each clock cycle to the current count value. A comparator 922 compares subsequent count values, outputs a 1 if the current count is less than the last count, which means the counter has been reset. Otherwise the comparator 922 outputs a zero.

The numeric output is a registered value that is copied from its previous value in a register 910 if the reference frame is set. Otherwise, the output of a switch 912 will be passed through a switch 914 to the output register 910. Switch 912 passes the previous register value if the controller is false and the value of a counter if the condition is true. The switch 1 is controlled by the condition whether a registered value of the counter is less than the previous counter value (If the current count is lower than the previous value then we know the counter has been reset). The counter is reset on a rate domain input pulse.

Delays 917 and 918 compensate the dataflow to be synchronized between the paths due to the delay in 916. Delay 926 compensates the dataflow to be synchronized between the paths due to the delay in 910. Adder 924 adds a constant value 928 of 1 to the output value because counter 920 is zero indexed.

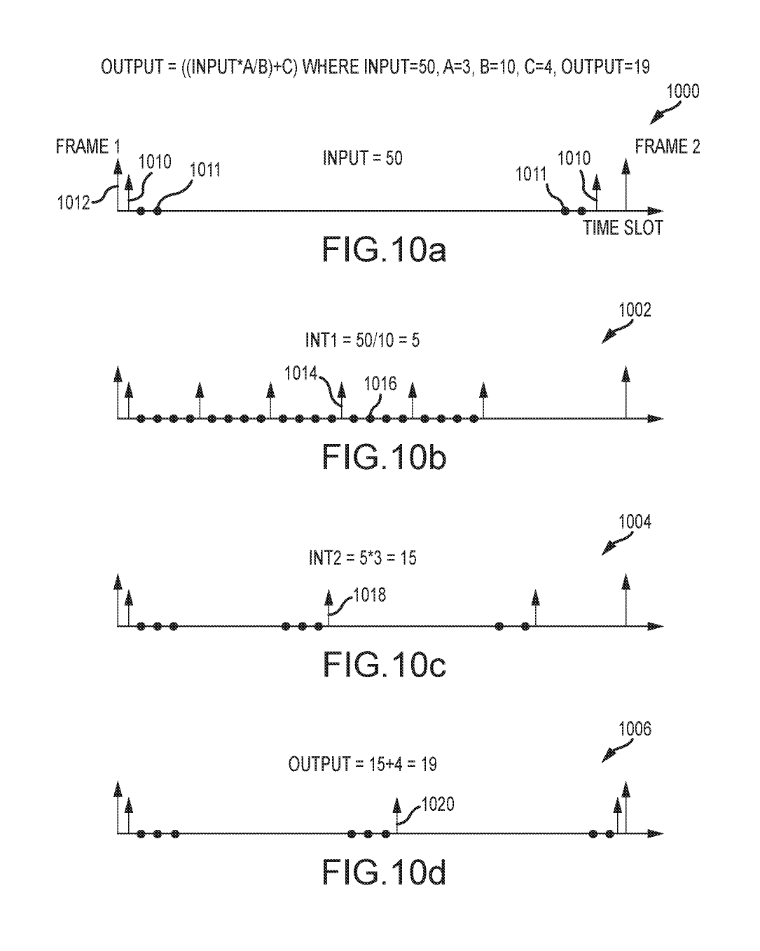

Referring now to FIGS. 10a-10d, rate domain serial data streams 1000, 1002, 1004 and 106 depict the input serial data stream and the intermediate serial data streams for the division, multiplication and addition operations for a simple calculation of output=((input/b)*a)+c where the input has a numeric value of 50, a=3, b=10, c=4 and the output=19 for a “pulse frequency” representation. Input serial data stream 1000 has 2 pulses 1010 separated by 49 null pulses 1011 in a frame 1012. This sequence repeats unless altered by processing. The division operation scales this down by a factor of 10 to one pulse 1014 every five time slots. This produces four null pulses 1016 between consecutive pulses 1014. The multiplication operation scales this up by a factor of 3 to one pulse 1018 every 15 time slots. The addition operation scales this up by a factor of 19/15 to one pulse 1020 every 20 time slots.

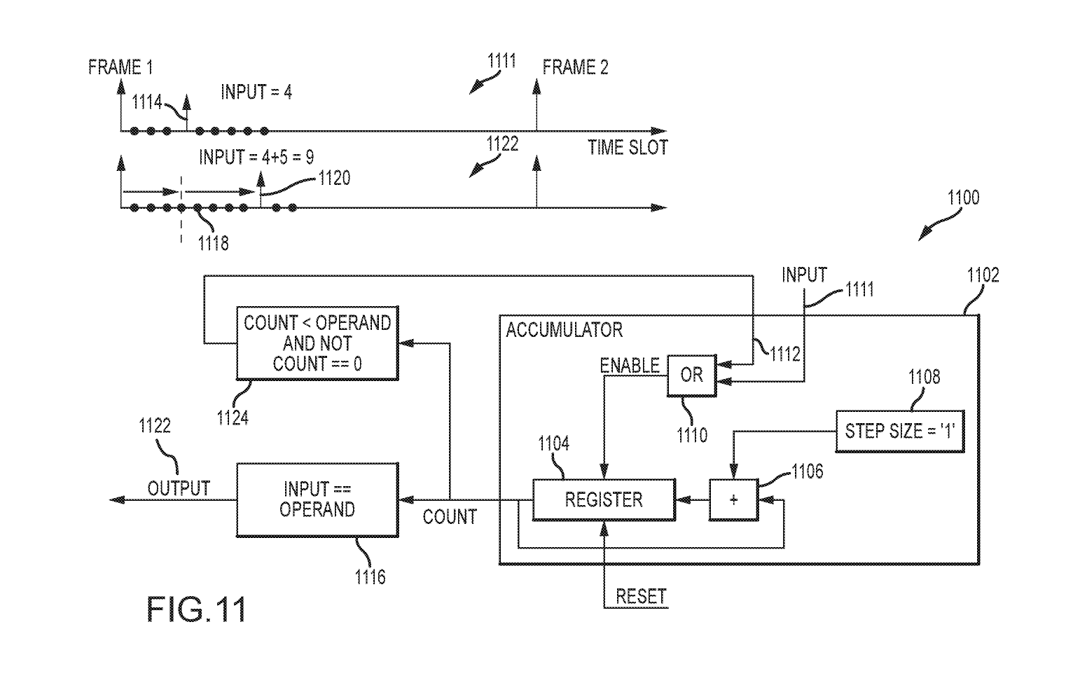

Referring now to FIG. 11, an embodiment of an adder 1100 is used to illustrate the principles of rate domain numerical processing for a weighted “pulse position” representation as shown in FIG. 2c. The occurrence of a pulse is weighted by the position of that pulse. The adder shifts the position of an input pulse by the addend. For example, a frame having a value of 4 has a pulse in the 4^{th} position (time slot). Adding a value of 5 shifts the pulse to the 9^{th} position (time slot).

Adder 1100 includes a modified accumulator 1102 including a standard feedback configuration of a register 1104 and adder 1106 for a given step-size 1108. The accumulator is modified by ORing (OR gate 1110) the input serial data stream 1111 with an adder set 1112 to enable register 1104. Adder set 1112 is initially set to zero on a frame reset of register 1104. Upon the occurrence of a pulse 1114 in input serial data stream 1111, OR gate 1110 enables register 1104 to increment the count. A comparator 1116 compares the count to the operand (addend). If they are not equal, the comparator generates a null pulse 1118. If they are equal, the comparator generates a pulse 1120 in the shifted position in an output serial data stream 1122. A comparator 1124 compares the count to zero and to the operand (addend). If the count is not zero and less than the operand, comparator 1124 switches adder set 1112 to a value of 1. This has the effect of enabling register 1104 and counting clock cycles (time slots) up until the operand value is reached to generate pulse 1120 in the shifted position. At this point, adder set is switched back to a value of 0 and the adder waits for the next frame.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A numerical processing method, comprising:
receiving an input serial data stream on a single input wire, the input serial data stream representing a multi-valued number as a rate of pulse events including pulses, null pulses or a combination thereof;
scaling the rate by an operand in an output serial data stream to perform a multiplication, division, addition or subtraction operation; and
outputting the output serial data stream on a single output wire.

2. The method of claim 1, wherein the rate is a number of pulse events per frame.

3. The method of claim 2, wherein the step of scaling the rate by the operand to perform the division operation comprises:
counting pulse events to form a count; and
when the count equals or exceeds the operand, generating a pulse event and resetting the count.

4. The method of claim 2, wherein the step of scaling the rate by the operand to perform the multiplication operation comprises:
for each pulse event, generating a number of pulse events equal to the operand.

5. The method of claim 2, wherein the step of scaling the rate by the operand to perform the addition operation comprises:
detecting a non-pulse event;
inserting a pulse event in place of the non-pulse event; and
repeating the steps of detection and insertion until a count reaches the operand.

6. The method of claim 1, wherein the rate is a frequency of pulse events.

7. The method of claim 6, wherein the step of scaling the rate by the operand to perform the division operation comprises:
computing the operand as a quotient of the multi-valued number and a divisor without using a binary divider circuit;
accumulating a count of non-pulse events after the occurrence of a pulse event;
generating a non-pulse event;
when the count equals or exceeds the operand, generating a pulse event and resetting the count.

8. The method of claim 6, wherein the step of scaling the rate by the operand to perform the multiplication operation comprises:
setting the operand equal to a multiplicand;
counting pulse events to form a count;
generating a non-pulse event;
when the count equals or exceeds the operand, generating a pulse event and resetting the count.

9. The method of claim 6, wherein the step of scaling the rate by the operand to perform the addition operation comprises:
computing the operand as sum of the multi-valued number and an addend;
accumulating a count of non-pulse events after the occurrence of a pulse event;
generating a non-pulse event;
when the count equals or exceeds the operand, generating a pulse event and resetting the count.

10. The method of claim 1, wherein the rate is a position of the pulse event in the serial data stream following a reset.

11. The method of claim 6, wherein the step of scaling the rate by the operand to perform the addition operation comprises:
detecting a pulse event;
counting non-pulse events to form a count;
generating non-pulse events; and
when count reaches the operand, generating a pulse event.

12. The method of claim 1, wherein the pulse events that represent the multi-valued number have equal weight.

13. The method of claim 1, wherein the pulse events that represent the multi-valued number have unequal weights determined by the position of the pulse event in the data stream.

14. The method of claim 1, wherein the step of scaling the rate by the operand is performed by binary logic circuitry.

15. The method of claim 1, further comprising:
deserializing the input serial data stream into a plurality of data streams;
parallel processing said plurality of data streams to scale the rate by the operand; and
serializing the plurality of processed data streams to form the output serial data stream.

16. The method of claim 1, further comprising:
converting the rate representation of the multi-valued numbers to a binary representation of the multi-valued numbers in the output serial data stream.

17. The method of claim 1, wherein the step of scaling the rate by the operand, comprises:
counting pulse events to form a count; and
comparing the count to the operand to generate a pulse event.

18. A numerical processing circuit, comprising:
an input configured to receive an input serial data stream on a single input wire, the input serial data stream representing a multi-valued number as a rate of pulse events including pulses, null pulses or a combination thereof;
a numeric input configured to receive an operand;
logic circuitry configured to scale the rate by the operand in an output serial data stream to perform a multi-valued arithmetic operation selected from multiplication, division, addition and subtraction or a combination thereof; and
an output configured to output the output serial data stream on a single output wire.

19. A numerical processing circuit for processing serial data in a rate domain, comprising:
an input configured to receive an input serial data stream on a single input wire, the input serial data stream representing a multi-valued number as a rate of pulse events including pulses, null pulses or a combination thereof;
a numeric input configured to receive an operand;
logic circuitry configured to count pulse events and compare the count to the operand to vary the rate of pulse events in an output serial data stream to perform a multi-valued arithmetic operation selected from multiplication, division, addition and subtraction or a combination thereof; and
an output configured to output the output serial data stream on a single output wire.

20. A numerical processing circuit, comprising:
an input configured to receive an input serial data stream on a single input wire, the input serial data stream representing a multi-valued number as a rate of pulse events including pulses, null pulses or a combination thereof;
a numeric input configured to receive an operand;
logic circuitry configured to use the operand to vary the rate of pulse events in an output serial data stream to perform a multi-valued arithmetic operation selected from multiplication, division, addition and subtraction or a combination thereof; and
an output configured to output the output serial data stream on a single output wire.
